(19) United States
(12) Patent Application Publication
(10) Pub. No.: US 2019/0263188 A1
(43) Pub. Date: Aug. 29, 2019

(54) TIRE TREADS HAVING DISCONTINUITIES EXTENDING DEPTHWISE ALONG NON-LINEAR PATHS

(71) Applicants: John Limroth, Simpsonville, SC (US); Mark Collett, Simpsonville, SC (US)

(72) Inventors: John Limroth, Simpsonville, SC (US); Mark Collett, Simpsonville, SC (US)

(73) Assignee: Compagnie Générale des Établissements Michelin, Clermont-Ferrand (FR)

(21) Appl. No.: 16/346,334

(22) PCT Filed: Oct. 30, 2017
(86) PCT No.: PCT/US2017/059053

§ 371 Date: Apr. 30, 2019

(30) Foreign Application Priority Data
Oct. 31, 2016 (US) PCT/US2016/059791

(51) Int. Cl. B60C 11/12; B60C 11/13

(52) U.S. Cl. CPC B60C 11/1218; B60C 11/124; B60C 11/1315

(57) ABSTRACT

The invention includes a tire tread having one or more lateral discontinuities (26), each discontinuity extending into the tread thickness along a non-linear path. The lateral discontinuity extends from a first terminal end (40) to a second terminal end (42), the first terminal end being located closest to an outer, ground-engaging side relative to the second terminal end. The non-linear path can be described as extending from a first portion (A1, A2, A3), to an intermediate portion (B1), and then to a third portion (C1) when extending towards the second terminal end. The first portion has a low average inclination angle, the intermediate portion has a negative average inclination angle, and the third portion has a positive average inclination angle, each angle being measured relative to the depthwise direction of the tread. A positive angle is angled in the direction of intended tire rotation (R) as the tread thickness extends outward towards the outer, ground-engaging side.

### CROSS-REFERENCE TO RELATED APPLICATIONS

This application claims priority to, and the benefit of, International patent application no. PCT/US2016/059791, filed Oct. 31, 2016 with the US Patent Office, in its capacity as a Receiving Office, the disclosure of which is hereby incorporated by reference.

### BACKGROUND

### Field

This invention relates generally to tire treads, and more particularly, to tire treads having discontinuities extending into the tread thickness, such as grooves and sipes, where the discontinuities extend into the tread depth along a non-linear path.

### Description of the Related Art

Tire treads are known to include a pattern of discontinuities forming a tread pattern arranged along an outer, ground-engaging side of the tread to provide sufficient traction and handling performance during particular operating conditions. Discontinuities may comprise grooves and/or sipes. Grooves provide void into which water, mud, or other environmental materials may be diverted to better allow the outer, ground-engaging side of the tread to engage a tire operating surface (that is, a surface upon which the tire operates, such as a road or ground surface). Sipes are slits or narrow grooves that at least partially close when engaging a tire operating surface, but which provide edges along the outer, ground-engaging side of the tread to generate traction. By virtue of providing a pattern of discontinuities, tread elements comprising ribs and/or lugs are formed in the tread.

It is well known that the tire tread wears during tire operation as the tire tread slips relative the tire operating surface at the trailing edge of a tread element within a tire footprint. The tire footprint is the area of contact between the tire and the tire operating surface, and which is also referred to as a contact patch. Therefore, there is a desire to reduce this slip and the impact this slip has on tread wear during tire operation.

While it is known to alter the depthwise inclination of a lateral sipe by rotating the depthwise inclination of the lateral sipe in the direction of tire rotation and in the direction of the tread length as the lateral sipe extends outwardly from the tread depth and towards the outer, ground-engaging side of the tread (which is referred to as being positively inclined) to improve wear performance, it has been determined that improvements in tread wear are not consistently observed through the worn life of the tread. Therefore, there is a need to improve the consistency of tread wear performance over the worn life of the tread when employing positively inclined lateral sipes or lateral grooves.

### SUMMARY

Embodiments include tire treads, tires having such treads, and methods of using the tire treads.

In particular embodiments, a tire tread has one or more lateral discontinuities, each discontinuity extending into the tread thickness along a non-linear path. Generally, the lateral discontinuity extends from a first terminal end and to a second terminal end, the first terminal end being located closest to an outer, ground-engaging side relative to the second terminal end. The non-linear path can be described as extending from a first portion, to an intermediate portion, and then to a third portion when extending towards the second terminal end. The first portion has a low average inclination angle, the intermediate portion has a negative average inclination angle, and the third portion has a positive average inclination angle, each angle being measured relative to the direction of the tread thickness (the depthwise direction of the tread). A positive angle is angled in the direction of intended tire rotation as the tread thickness extends towards the outer, ground-engaging side.

In particular embodiments, a tire tread includes a length extending in a longitudinal direction, the lengthwise direction being a circumferential direction when the tread is arranged on a tire, a width extending in a lateral direction, the lateral direction being perpendicular to the longitudinal direction, and a thickness extending in a depthwise direction from an outer, ground-engaging side of the tread, the depthwise direction being perpendicular to both the longitudinal direction and the widthwise direction of the tread. The tire tread also includes a lateral discontinuity having a length and a height, the length extending primarily in the lateral direction of the tread and the height in the direction of the tread thickness. The lateral discontinuity, however, extends into the tread thickness along a non-linear path that extends at least partially in the direction of the tread thickness (that is, at least partially in the direction of the lateral discontinuity height). The lateral discontinuity is formed between a pair of opposing faces of the tread. A first face of the pair of opposing faces extends along a first path within the tread thickness, the first path extending from a first terminal end and to a second terminal end of the first face, the first terminal end being arranged closest to the outer, ground-engaging side relative to the second terminal end, the first path extending deeper into the tread thickness from the first terminal end at a first inclination angle measured in the longitudinal direction of the tread relative to the depthwise direction as the first path extends and an origin located below the first inclination angle. In this embodiment, the first inclination angle is a low angle ranging from −10 to +20 degrees. The first face extends deeper into the tread thickness towards the second terminal end from the first inclination angle along the first path to an intermediate location of the first path located between the first terminal end and the second terminal end of the first face, where in the intermediate location the first path extends at a second inclination angle measured in the longitudinal direction of the tread relative to the depthwise direction and an origin located below the intermediate location. The second angle is angled away from an intended forward rotating direction of the tread relative to the second terminal end. The first face extends deeper into the tread thickness from the second inclination angle at the intermediate location and towards the second terminal end of the first face to a subsequent location along the first path, the first path extending at a third inclination angle at the subsequent location. The third inclination angle is measured in the longitudinal direction of the tread relative to the depthwise direction and an origin located below the first inclination angle. The third inclination angle is angled in the intended forward rotating direction of the tread relative to the second terminal end of the first face.

The foregoing and other objects, features, and advantages of the various embodiments will be apparent from the following more detailed descriptions of particular embodiments, as illustrated in the accompanying drawings wherein like reference numbers represent like parts of particular embodiments.

### DETAILED DESCRIPTION OF THE DRAWINGS

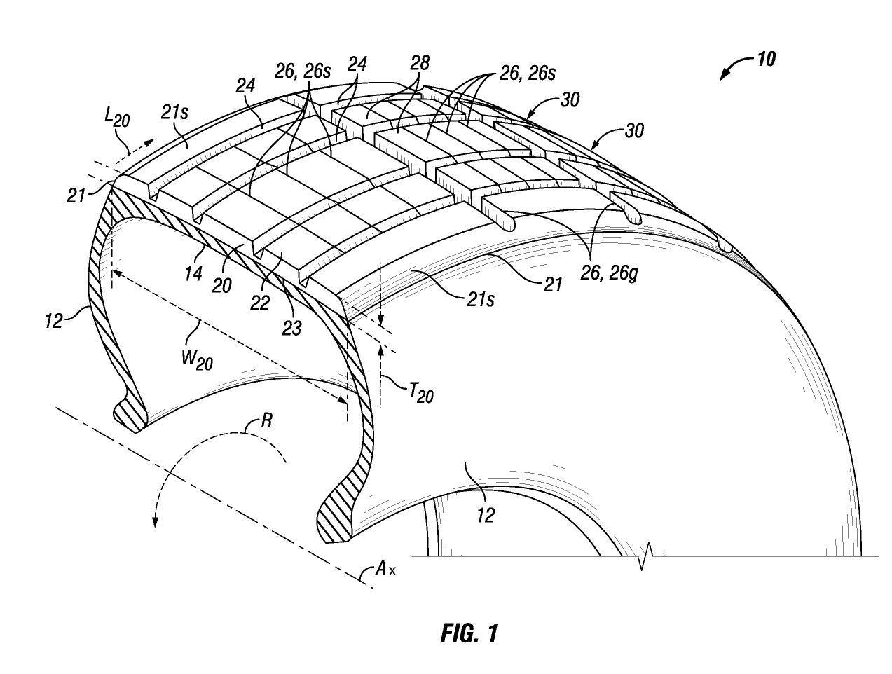

FIG. 1 is a partial perspective view of a tire tread showing a plurality of tread blocks separated by a plurality of discontinuities forming a plurality of lateral and longitudinal grooves and a plurality of sipes, in accordance with an exemplary embodiment.

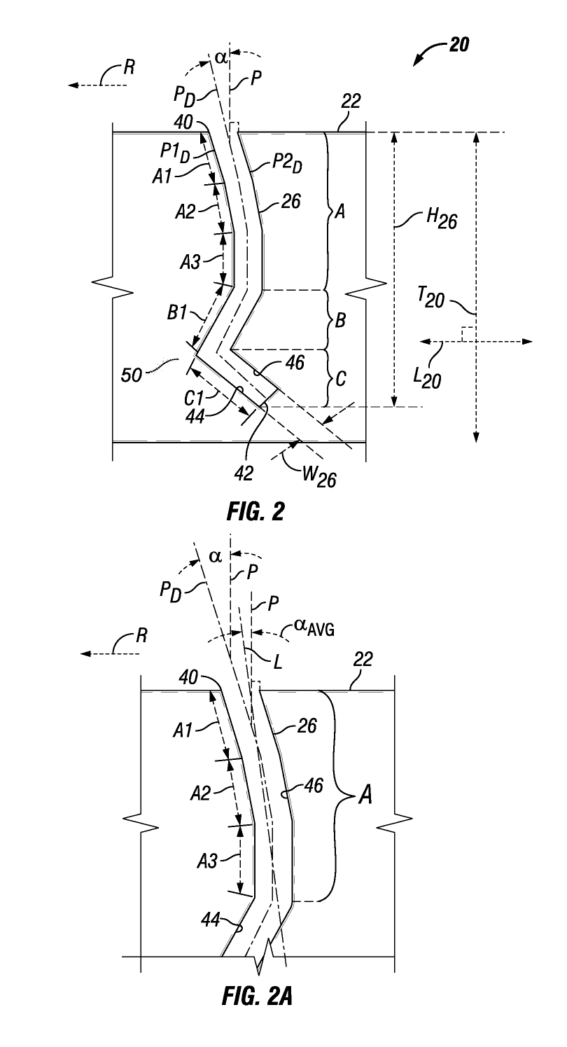

FIG. 2 is a side view of a lateral discontinuity, comprising a lateral sipe or lateral groove, such as for use in the tire tread of FIG. 1, in accordance with an exemplary embodiment.

FIG. 2A is close-up view of the first portion of the lateral discontinuity shown in FIG. 2.

FIG. 3 is a top elevational view showing the discontinuity of FIG. 2 extending linearly along its length, which extends in the lateral direction of the tire tread, in accordance with an exemplary embodiment.

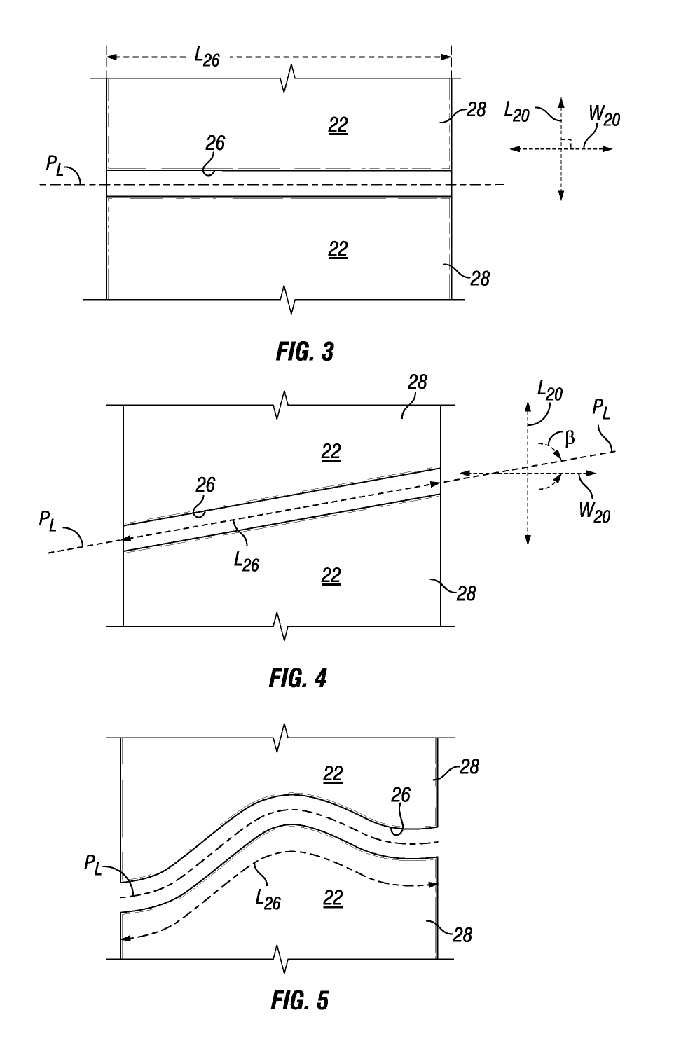

FIG. 4 is a top elevational view showing the discontinuity of FIG. 2 optionally extending linearly along its length, which extends partially in the lateral direction (that is, biased to the lateral direction) of the tire tread, in accordance with an exemplary embodiment.

FIG. 5 is a top elevational view showing the discontinuity of FIG. 2 optionally extending non-linearly along its length, in accordance with an exemplary embodiment.

### DETAILED DESCRIPTION OF PARTICULAR EMBODIMENTS

The present invention includes tire treads, tires including said treads, and methods for improving tire wear, where a lateral discontinuity, such as when forming a sipe or a groove, extends within the tread thickness along a non-linear path. This path is defined to extend midway between a pair of opposing faces of the tire tread that form the lateral discontinuity, the path extending midway between these opposing faces for the full depth of the lateral discontinuity.

In measuring the angularity of the non-linear path, and any portion thereof, or the path along which any face forming the discontinuity extends, as discussed herein, from the direction of the tread thickness, “the direction of the tread thickness” is also referred to as the “depthwise” direction of the tread. “The direction of the tread thickness” extends perpendicular to the tread width and the tread length. When the tire tread is installed on an annual tire, “the direction of the tread thickness” is a radial direction, extending radially from a rotational axis of the tire. Consistent therewith, such angularity can also be measured relative to a plane extending in both the direction of the tread width and the direction of the tread thickness, where “the direction of the tread thickness” extends along this plane. Angularity is measured with reference to a reference line extending in the direction of the tread thickness or the plane and an origin located on the reference line or plane as the subject portion of any path being measured extends toward the outer, ground-engaging side of the tread from within the tread thickness. This origin is not necessarily the location for measuring the angle, but rather a location to describe a positively or negatively biased angle. It is noted that a positive angle is an angle that is angled or biased in the direction of intended tire rotation as the tread thickness extends towards the outer, ground-engaging side, while a negative angle is angle or biased in the opposite direction. Any non-zero angle can be expressed as forming two vectors, one vector extending in the direction of the tread thickness towards the outer, ground-engaging side and the other vector extending in the longitudinal direction of the tread, where for a positive angle, this latter (second) vector extending in the longitudinal direction extends in the direction of intended forward tire rotation, and where for a negative angle, this latter vector extends in the direction opposite to the direction of intended forward tire rotation (that is, in the direction of intended reverse tire rotation). The direction of intended forward rotation is the direction the tire rotates when the vehicle upon which it is mounted travels in a forward direction, that is, in the direction opposite of a reverse direction. Any portion of the tread positively inclined leans in the direction of intended forward rotation as the portion of the tread extends from within the tread thickness and towards the outer, ground-engaging side of the tread.

Referring now to the non-linear path, the path extends deeper into the tread thickness from a first portion, where the first portion is generally inclined at a low angle (inclination angle) relative to the direction of the tread thickness, or a plane extending in both the directions of the tread width and tread thickness, the angle extending outwardly towards the outer, ground-engaging side from an origin located along the plane and below the outer, ground-engaging side of the tread or the first portion. The low angle may range from a low positive angle to a low negative angle. From the first portion, the lateral discontinuity extends deeper into the tread thickness to an intermediate portion (also referred to as a “second portion”) and ultimately to a third portion. At least a portion of the non-linear path in the intermediate portion is negatively inclined (that is, angled away from the direction of intended forward tire rotation by a second angle (inclination angle) relative to the direction of the tread thickness, or a plane extending in both the directions of the tread width and tread thickness, the angle extending outwardly towards the outer, ground-engaging side from an origin located along the plane and below the outer, ground-engaging side of the tread or the intermediate portion). In the third portion, the non-linear path is again positively inclined (that is, angled towards the direction of intended forward tire rotation by a third angle (inclination angle) relative to the direction of the tread thickness, or a plane extending in both the directions of the tread width and tread thickness, the angle extending outwardly towards the outer, ground-engaging side from an origin located along the plane and below the outer, ground-engaging side of the tread or the third portion). As a consequence of the non-linear path extending along the different angles at the different locations as previously noted, an undulation is formed along the non-linear path. In particular instances, for example, the path includes an undulation when extending from the first angle and to the third angle, the second angle being arranged within the undulation. As a result, tire tread wears experiences improved tread wear, or more consistent tread wear, over the worn life of the tread using the non-linear discontinuity. Variations of the lateral discontinuity are described further below.

As a lead-in to further discussions surrounding the lateral discontinuities, a tire tread is more generally introduced. A tire tread can generally be described as having a length extending in a longitudinal direction. As the tread may be formed with the tire, or separately for later installation on the tire, such as during retreading operations, for example, the lengthwise direction of the tread is a circumferential (that is, annular) direction when the tread is arranged on a tire. A tire tread also has a width extending in a lateral direction, the lateral direction being perpendicular to the longitudinal direction. A tire tread also has a thickness extending in a depthwise direction from an outer, ground-engaging side of the tread. The thickness terminates at a bottom side of the tread. Each of the depthwise direction, the longitudinal direction, and the widthwise direction of the tread is perpendicular to the other.

Returning now to further discussions surrounding the lateral discontinuities more generally introduced above, it is noted that the tread includes one or more lateral discontinuities, where any such discontinuity has a length and a height. The length extends at least partially or primarily in the lateral direction of the tread. The height extends in the direction of the tread thickness. In certain instances, the discontinuity has a width. It is appreciated that this width may be any width. In certain examples, the discontinuity is a groove or sipe. A sipe is generally a narrow groove, and in certain instances has a width that enables the width to close during tire operation when the tire is loaded in and within a tire footprint (the portion of the tire in contact with the ground)—the width closing at one or more locations along the depth of the sipe. For example, in certain instances, when the discontinuity is a groove, the width may be greater than 1.0 to 1.4 millimeters (mm). When the discontinuity is a sipe, in certain instances the width is less than 1.0 to 1.4 mm Because a sipe can be formed as a laceration, as opposed to being formed as a molded void, for example, when being formed as a laceration, the sipe does not have a width or, in other words, has a zero (0) width. The discontinuity widths described herein are made with reference to the tread when installed on an annular tire (in a normally pressurized state or non-pressurized state, and not in a loaded state, such as when installed on a vehicle) or within an annular mold (such as when the tread is molded with the tire or when molded in an annular tread mold)

Previously, lateral discontinuities have been described as extending along a non-linear path as the lateral discontinuity extends deeper into the tread thickness from a first portion, where the first portion includes a low inclination angle. In certain examples, the positive inclination angle for the first portion includes any angle from −10 to +20 degrees, −5 to +10 degrees, or 0 to +5 degrees, to be measured as described above for the first angle or otherwise herein relative to the direction of the tread thickness or the plane. As previously noted, from the first portion, the non-linear path extends to an intermediate portion (that is, a “second portion”), where the intermediate portion includes a negative inclination angle. In certain examples, the negative inclination angle in the intermediate portion includes any angle from −10 to −50 degrees, −20 to −40 degrees, or −25 to −30 degrees, to be measured as described above for the second angle or otherwise herein relative to the direction of the tread thickness or the plane. Also as previously noted, the non-linear path extends further into the thickness of the tread from the intermediate portion to a third portion, where the third portion includes a positive inclination angle. For example, the positive inclination angle in the third portion includes any from +30 to +80 degrees, +40 to +70 degrees, or +50 to +60 degrees, to be measured as described above for the third or and otherwise herein relative to the direction of the tread thickness or the plane.

As for the first and third portions, while at least a portion of the path is said to be characterized as having a low inclination angle or positive inclination angle, respectively, in more specific instances, each of the first and third portions of the non-linear path can be characterized as having an average inclination angle that is low or positive, respectively. This average inclination angle is determined by averaging the inclination angles for the corresponding first or third portion over the full length of the corresponding first or third portion. This average inclination angle may be obtained by using linear regression when any portion is non-linear. In such instances, linear regression is used to determine a line based upon the non-linear path along which the corresponding portion extends. The average inclination angle is then the angle by which the line is biased from the direction of the tread thickness or the plane in the same manner as measuring any of the corresponding first, second, or third angles, respectively. In certain instances, this average inclination angle for the first portion ranges from −10 to 20 degrees, −5 to +10, or 0 to 5 degrees, to be measured as described above for the first angle or otherwise herein relative to the direction of the tread thickness or the plane. In certain instances, this average inclination angle for the third portion ranges from +30 to +80 degrees, +40 to +70 degrees, or +50 to +60 degrees, to be measured as described above for the third angle or otherwise herein relative to the direction of the tread thickness or the plane. In yet other instances, the third portion of the path has a positive inclination angle at all locations along the full length of the third portion.

As for the intermediate portion, while at least a portion of the path is said to be characterized as having a negative inclination angle, in more specific instances, the intermediate portion of the non-linear path is characterized as having an average inclination angle that is negative. This average inclination angle is determined by averaging the inclination angles for the intermediate portion over the full length of the intermediate portion, which includes using linear regression as describe above. In certain instances, this average inclination angle for the intermediate portion measures −10 to −50 degrees, −20 to −40 degrees, or −25 to −30 degrees, to be measured as described above for the second angle or otherwise herein relative to the direction of the tread thickness or the plane. In yet other instances, the intermediate portion has a negative inclination angle at all locations along the full length of the intermediate portion.

It is appreciated that any one or more—or all—of the first, second, and third portions, or any additional portions that may be included within the non-linear path, partially or fully form one or multiple curvilinear increments. In certain instances, the full non-linear path is curvilinear (that is, smoothly contoured). It is also appreciated that any one or more—or all—of the first, second, and third portions, or any additional portions that may be included within the non-linear path, may be partially or fully formed of one or multiple linear increments. In certain instances, the full non-linear path is formed of a plurality of linear increments. It is also appreciated that the non-linear path may be formed of a combination of linear and curvilinear portions. In any embodiment, the increments may be equal or unequal in length or in height (the height being the distance each increment extends in the direction of the tread thickness, where the length can be separated into two vectors, one extending in the direction of the tread thickness and the other in the direction of the tread length). In one example, where all increments extend substantially the same height within the tread thickness, the first portion of the path is formed of three (3) linear increments, the first and second increments extending at a +5 degree inclination and the third increment extending at a zero (0) degree inclination, as measured as described above for the first angle or otherwise herein relative to the direction of the tread thickness or the plane. In the example, the intermediate portion extends from the third increment of the first portion and is formed of a single increment extending at a −25 degree inclination, as measured as described above for the second angle or otherwise herein relative to the direction of the tread thickness or the plane, and the third portion is formed of a single increment, the single increment extending from the intermediate portion at a +60 degree inclination, as measured as described above for the third angle or otherwise herein relative to the direction of the tread thickness or the plane.

Other inclination angles and average inclination angles for any non-linear path described herein are contemplated and may be selected for use with any lateral discontinuity on a particular tire tread and tire, provided the angles are positive, negative, or otherwise, regardless of degree, for each first, intermediate, and third portion as contemplated above, as variations in degree may be selected to optimize tire tread wear improvements for particular tread and tire designs.

While the lateral discontinuity has been described as extending depthwise within the tread thickness along a non-linear path, the discontinuity can also be described with reference to the pair of opposing faces of the tread that form and define the discontinuity.

As previously stated, a lateral discontinuity is formed by a pair of opposing faces of the tread, which may or may not be spaced apart to form a width of the lateral discontinuity. Each face of the pair of opposing faces extends generally in the depthwise direction of the tread thickness, which more specifically means that it extends at least partially in the depthwise direction. It can be said that each face of the pair of opposing faces forms a side of a tread element. A tread element is a tread block or lug, which may or may not be arranged with one or more other tread elements to form a rib. A rib extends along the length of the tread, and includes one or a plurality of tread blocks.

With regard to the pair of opposing faces, a first face of the pair of faces extends along a first path within the tread thickness, the first path extending from a first terminal end to a second terminal end of the first face. The first terminal end is arranged closest to the outer, ground-engaging side relative to the second terminal end. In particular embodiments, the first terminal end is arranged along the outer, ground-engaging side of the tread, while in other variations, such as when the discontinuity is a submerged discontinuity, which is exposed after a thickness of the tread is removed, such as due to wear, for example, the first terminal end is arranged within the tread thickness below the outer, ground-engaging side.

The first path is a non-linear path, and may form any non-linear path described in association with the non-linear path along which the lateral discontinuity extends as previously described. The first path can be further described as extending deeper into the tread thickness from a first portion, where the first portion is generally inclined at a low angle (inclination angle) relative to the direction of the tread thickness, or a plane extending in both the directions of the tread width and tread thickness, the angle extending outwardly towards the outer, ground-engaging side from an origin located along the plane and below the outer, ground-engaging side of the tread or the first portion. The low angle may range from a low positive angle to a low negative angle. From the first portion, the first path extends deeper into the tread thickness to an intermediate portion (also referred to as a “second portion”) and ultimately to a third portion. At least a portion of the first path in the intermediate portion is negatively inclined (that is, angled away from the direction of intended forward tire rotation by a second angle (inclination angle) relative to the direction of the tread thickness, or a plane extending in both the directions of the tread width and tread thickness, the angle extending outwardly towards the outer, ground-engaging side from an origin located along the plane and below the outer, ground-engaging side of the tread or the intermediate portion). In the third portion, the first path is again positively inclined (that is, angled towards the direction of intended forward tire rotation by a third angle (inclination angle) relative to the direction of the tread thickness, or a plane extending in both the directions of the tread width and tread thickness, the angle extending outwardly towards the outer, ground-engaging side from an origin located along the plane and below the outer, ground-engaging side of the tread or the third portion). As a consequence of the first path extending along the different angles at the different locations as previously noted, an undulation is formed along the first path. In particular instances, for example, the first path includes an undulation when extending from the first angle and to the third angle, the second angle being arranged within the undulation.

In summary, the first, second, and third inclination angles are measured at different locations along the first face as the first face, together with the lateral discontinuity, extends deeper into the tread depth along the first path. It can be said that the first angle is measured at a first location. While this first location is arranged closest to the first terminal end of the first face, relative to the locations at which the second and third angles are measured, it is appreciated that the first location may be arranged at any of a variety of locations. For example, in certain instances, the first location is the first terminal end of the first path. In other instances, the first location is located between the first terminal end and the intermediate location, such as where, for example, the first location is arranged within a first portion of the first path, the first portion extending from the first terminal end and to an intermediate (second) portion within which the intermediate location is arranged. It is also appreciated that the first location may be located at the junction of the first and intermediate portions of the first path. Just as the first location may be located anywhere from the second location to the first terminal end, in any embodiment contemplated herein, the second location can be located anywhere from the first location to the third location. For example, in certain instances, the second location is arranged within an intermediate (second) portion of the first path, the intermediate portion extending from the first and to the third portion. Likewise, the third location may be located anywhere from the second location to the second terminal end, such as along a third portion extending from the intermediate portion and to the second terminal end of the first path.

As stated previously, the first path for the first face may follow a path shaped the same as or within the same parameters as the non-linear path along which the discontinuity extends as described herein. Accordingly, in certain examples, the first inclination angle for the first portion of the first path includes any angle from −10 to +20 degrees, −5 to +10 degrees, or 0 to +5 degrees, to be measured as described above for the first angle of the first path or otherwise herein relative to the direction of the tread thickness or the plane. In certain instances, in extending from the first angle and to the second angle, the first path transitions to a reduced angle that is less than the first angle and equal to or greater than zero. Likewise, the second inclination angle in the intermediate portion of the first path may form any angle from −10 to −50 degrees, −20 to −40 degrees, or −25 to −30 degrees, to be measured as described above for the second angle of the first path or otherwise herein relative to the direction of the tread thickness or the plane. Further, the third inclination angle in the third portion of the first face may form any angle from +30 to +80 degrees, +40 to +70 degrees, or +50 to +60 degrees, to be measured as described above for the third angle of the first path or otherwise herein relative to the direction of the tread thickness or the plane. In certain instances, the first path, in extending from the second inclination angle and to the third inclination angle, transitions from the second inclination angle to a subsequent inclination angle that is equal to or greater than zero and less than the third angle.

As with the non-linear path along which the discontinuity extends, for the first and third portions of the first path, at least a portion of each path is said to be characterized as having a low inclination angle or a positive inclination angle, respectively. In more specific instances, any one or both of the first and third portions of the first path are characterized as having an average inclination angle that is low or positive, respectively. Each average inclination angle is determined by averaging the inclination angles for the corresponding first or third portion over the full length of the corresponding first or third portion. This average inclination angle may be obtained by using linear regression when any portion is non-linear. In such instances, linear regression is used to determine a line based upon the non-linear path along which the corresponding portion extends. The average inclination angle is then the angle by which the line is biased from the direction of the tread thickness or the plane in the same manner as measuring any of the corresponding first, second, or third angles, respectively. In certain instances, this average inclination angle for the first portion of the first face ranges from −10 to +20 degrees, −5 to +10 degrees, or 0 to +5 degrees, to be measured as described above for the first angle of the first path or otherwise herein relative to the direction of the tread thickness or the plane. In certain instances, this average inclination angle for the third portion of the first face ranges from +30 to +80 degrees, +40 to +70 degrees, or +50 to +60 degrees, to be measured as described above for the third angle of the first path or otherwise herein relative to the direction of the tread thickness or the plane. In yet other instances, the third portion of the first path has a positive inclination angle at all locations along the full length of the third portion. As for the intermediate portion of the first path, while at least a portion of the path is said to be characterized as having a negative inclination angle, in more specific instances, the intermediate portion of the first path is characterized as having an average inclination angle that is negative. This average inclination angle is determined by averaging the inclination angles for the intermediate portion over the full length of the intermediate portion, which includes using linear regression as described above. In certain instances, this average inclination angle for the intermediate portion measures −10 to −50 degrees, −20 to −40 degrees, or −25 to −30 degrees, to be measured as described above for the second angle of the first path or otherwise herein relative to the direction of the tread thickness or the plane. In yet other instances, the intermediate portion has a negative inclination angle at all locations along the full length of the intermediate portion.

It is appreciated that any one or more—or all—of the first, second, and third portions, or any additional portions that may be included within the first path, partially or fully form one or multiple curvilinear increments. In certain instances, the full first path is curvilinear (that is, smoothly contoured). It is also appreciated that any one or more—or all—of the first, second, and third portions, or any additional portions that may be included within the first path, may be partially or fully formed of one or multiple linear increments. In certain instances, the full first path is formed of a plurality of linear increments. It is also appreciated that the first path may be formed of a combination of linear and curvilinear portions. In any embodiment, the increments may be equal or unequal in length or in height (the height being the distance each increment extends in the direction of the tread thickness, where the length can be separated into two vectors, one extending in the direction of the tread thickness and the other in the direction of the tread length). In one example, where all increments extend substantially the same height within the tread thickness, the first portion of the first path is formed of three (3) linear increments, the first and second increments extending at a +5 degree inclination and the third increment extending at a zero (0) degree inclination, to be measured as described above for the first angle of the first path or otherwise herein relative to the direction of the tread thickness or the plane. In the example, the intermediate portion extends from the third increment of the first portion and is formed of a single increment extending at a −25 degree inclination, to be measured as described above for the second angle of the first path or otherwise herein relative to the direction of the tread thickness or the plane, and the third portion is formed of a single increment, the single increment extending from the intermediate portion at a +60 degree inclination, to be measured as described above for the third angle of the first path or otherwise herein relative to the direction of the tread thickness or the plane.

It is appreciated that the second face of the pair of opposing faces that form and define the lateral discontinuity extends depthwise along a second path, the second path extending in any manner as contemplated with the first path above. This contemplates the second path extending along the same path or a different path within the same parameters described above in association with the first path. With further regard to the discontinuity length, it is appreciated that the length may extend along any linear or non-linear path, biased or not to the lateral direction of the tire tread and that the width may be constant or variable as the discontinuity extends depthwise and/or in the lengthwise direction of the lateral discontinuity. Lastly, it is appreciated that any tire tread described herein may be used with and attached to any type of tire, such as any pneumatic tire or a non-pneumatic tire, for example. Further, any such tire tread may associated with a new tire, or a retreaded tire, and may be formed prior to or after installation upon a tire.

Exemplary embodiments of the tire treads discussed above will now be described in further detail below in association with the figures listed above.

With reference to an exemplary embodiment of FIG. 1, a pneumatic tire 10 is shown. The tire 10 includes a pair of sidewalls 12 each extending radially outward from a rotational axis Ax of the tire and to a central portion 14 of the tire 10. The central portion 14 of the tire includes a tread 20 having a thickness T₂₀ extending depthwise in a radial direction toward the rotational axis Ax of the tire from an outer, ground-engaging side 22 of the tread 20 to a bottom side 23 for attachment and bonding to the tire. The tread also has a width W₂₀ extending in a lateral direction between a pair of opposing, lateral sides or side edges 21 of the tread arranged adjacent to sidewalls 12. The tread also includes a pair of shoulders 21s arranged along each side 21 extending along the tread thickness T₂₀. With regard to the tread 20, it is shown to include a plurality of longitudinal grooves 24 having a length extending in the direction of the tread length L₂₀, which in this instance is in a circumferential direction of the tire. The longitudinal grooves 24, together with lateral discontinuities 26, define a plurality of tread elements 28. Lateral discontinuities comprise lateral grooves 26g and lateral sipes 26s. Tread elements 28 arranged adjacent one another to form a row of tread elements extending in the direction of the tread length form a rib 30. The plurality of ribs include a pair of shoulder ribs 28s bounded by a lateral side 21 of the tread width W₂₀.

With reference now to FIG. 2, an exemplary lateral discontinuity 26 is shown, which may form a lateral groove 26g or lateral sipe 26s shown in FIG. 1, for example. In the exemplary lateral discontinuity shown, the lateral discontinuity has a width W₂₆ and a height T₂₆ that extends into the depth of the tread thickness T₂₀ between a first terminal end 40 and a second terminal end 42 along a non-linear path P_{D}. This path P_{D} is defined to extend midway across the width W₂₆ between a pair of opposing faces 44, 46 of the tire tread 20 forming the lateral discontinuity 26, the path extending midway between these opposing faces 44, 46 for the full depth of the lateral discontinuity. While variable widths are contemplated for the lateral discontinuity, in the embodiment shown, width W₂₆ remains constant along the depthwise extension of the lateral discontinuity. With brief reference to the opposing terminal ends 40, 42 of the depthwise extension of lateral discontinuity 26, the first terminal end 40 is located closest to the outer, ground-engaging side 22 of the tread 20 relative to the second terminal end 42. While it is contemplated that the first terminal end 40 may be arranged below the outer, ground-engaging side 22, such as when the lateral discontinuity 26 is a submerged discontinuity intended to become exposed to the outer, ground-engaging side 22 after an intervening thickness of the tire tread is worn away or otherwise removed, in the embodiment shown, the first terminal end 40 is arranged along the outer, ground-engaging side 22.

With continued reference to FIG. 2, non-linear path P_{D} extends deeper into the tread thickness T₂₀ from a first portion A, where the first portion is inclined at a low angle. In this embodiment, at least along a portion of the first portion, this low angle is angled towards the direction of intended forward tire rotation R by angle α taken along the first portion A as the first portion or low angle extends outwardly from within the tread thickness T₂₀ and towards the outer, ground-engaging side 22, such as from any origin located along a plane P below the outer, ground-engaging side 22 or below first portion A. This plane P extends both in a direction of the tread width (not shown) and the tread thickness T₂₀, and also represents a reference line extending in the direction of the tread thickness T₂₀. From the first portion A, the non-linear path P_{D} extends deeper into the tread thickness to an intermediate portion B (a “second portion”) and ultimately to a third portion C. At least a portion of the non-linear path P_{D} in the intermediate portion B is negatively inclined, that is, angled away from the direction of intended forward tire rotation by angle α taken along portion B as the intermediate portion or negative angle extends outwardly from within the tread thickness T₂₀ and towards the outer, ground-engaging side 22, such as from any origin located along a plane P below the outer, ground-engaging side 22 or below intermediate portion B. This plane P extends both in a direction of the tread width (not shown) and the tread thickness T₂₀, and also represents a reference line extending in the direction of the tread thickness T₂₀. In the third portion C, the non-linear path P_{D} is again positively inclined, that is, angled towards the direction of intended forward tire rotation R by angle α taken along portion C as the third portion or positive angle extends outwardly from within the tread thickness T₂₀ and towards the outer, ground-engaging side 22, such as from any origin located along a plane P below the outer, ground-engaging side 22 or below third portion C. This plane P extends both in a direction of the tread width (not shown) and the tread thickness T₂₀, and also represents a reference line extending in the direction of the tread thickness T₂₀. As a consequence of the non-linear path P_{D} extending along the different angles at the different locations as previously noted, an undulation 50 is formed along the non-linear path. In the exemplary embodiment shown, the path P_{D} includes an undulation 50 when extending from the first portion A and to the third portion C, the intermediate portion B being arranged within the undulation.

The exemplary embodiment of FIG. 2 provides an optional configuration of non-linear path P_{D}, where each of the first, second, and third portions A, B, C are formed of one or more of linear increments. In this example, the first portion A of path P_{D} is formed of three (3) linear increments A1, A2, A3 the first and second increments A1, A2 extending at a 5 degree inclination angle α and the third increment extending at a zero (0) degree inclination angle α as measured relative to plane P. Intermediate portion B extends from the third increment A3 of the first portion A and is formed of a single increment B1 extending at a −25 degree inclination angle α as measured relative to plane P. Third portion C is formed of a single increment C1, the first increment C1 extending from the intermediate portion B at a 60 degree inclination angle α relative to plane P. Because certain increments A1 through C1 extend at different angles relative to plane P, and because each increment extends the same distance into the tread thickness T₂₀ in the direction of the lateral discontinuity height H₂₆, the length of certain increments are longer than others. It is appreciated that the path P_{D} may easily be transformed into a curvilinear path, or at least portions thereof, while maintaining the effectiveness of the lateral discontinuity in improving tread wear.

Path P_{D} as shown in FIG. 2 can also be described as the first portion A having at any location an inclination angle α ranging from −10 to +20 degrees, −5 to +10 degrees, or 0 to +5 degrees as measured relative to plane P, the intermediate portion B having at any location an inclination angle α ranging from −10 to −50 degrees, −20 to −40 degrees, or −25 to −30 degrees as measured relative to plane P, and the third portion C having at any location an inclination angle α measuring +30 to +80 degrees, +40 to +70 degrees, or +50 to +60 degrees relative to plane P.

Path P_{D} as shown in FIG. 2 can also be described with regard to average inclination angles, where each of the first, second, and third portions are characterized as having an average inclination angle. Any such average inclination angle is determined by averaging all of the inclination angles α for a given portion A, B, C over the full length of such portion. For path P_{D} as described in FIG. 2, and now with reference to FIG. 2A, in first portion A, the average inclination angle α_{AVG} is measured along line L, which represents the average angle over the full length of first portion A, such as may be determined using linear regression, for example, is within the range of −10 to +20 degrees or 0 to +20 degrees as measured relative to plane P. Referring back to FIG. 2, the average inclination angle (not shown) in third portion C is +30 to +80 degrees, +40 to +70 degrees, or +50 to +60 degrees as measured relative to plane P, and the average inclination angle (not shown) in intermediate portion B is −25 degrees or within the range of −10 to −50 degrees, −20 to −40 degrees, or −25 to −30 degrees as measured relative to plane P.

While the lateral discontinuity has been described in FIG. 2 as extending depthwise within the tread thickness T₂₀ along a non-linear path P_{D}, the discontinuity can also be described with reference to the pair of opposing faces 44, 46 of the tread that form and define the lateral discontinuity 26. Specifically, the first face 44 of the pair of opposing faces extends along a first path P1_{D}, while the second face 46 of the pair of opposing faces extends along a second path P2_{D}. Because the width W₂₆ of the lateral discontinuity 26 remains constant along the depthwise extension of the lateral discontinuity 26, the first and second paths P1_{D}, P2_{D} along which the first and second faces 44, 46 respectively follow are the same as non-linear path P_{D} as described above. Of course, in other variations, first path P1_{D} may be different from the second path P2_{D} and one or both of the first and second paths P1_{D}, P2_{D} may be different form path P_{D} while still remaining within the ranges described herein for inclination angles and average inclination angles.

As stated more generally above, the length of the lateral discontinuity may extend along any desired path at least partially extending in a lateral direction of the tire tread. With reference to FIG. 3, a top elevational view of the lateral discontinuity 26 shown in FIG. 2 is depicted extending into the outer, ground-engaging side 22 of the tread 20. The length L₂₆ of the lateral discontinuity 26 is shown extending linearly along path P_{L} in the lateral direction W₂₀ of the tire tread (that is, in the direction of the tread width), unbiased thereto. Optionally, in other exemplary instances, with reference to FIG. 4, a lateral discontinuity 26 is shown extending linearly along its length L₂₆ along path P_{L}, but which extends partially in the lateral direction W₂₀ of the tire tread. That is, in other words, the path P_{L} is biased to the lateral direction of the tire tread by any angle β so long as the angle is equal to or less than 45 degrees. In another optional exemplary instance, with reference to FIG. 5, a lateral discontinuity 26 is shown extending non-linearly along its length L₂₆ along path P_{L} in the lateral direction W₂₀ of the tire tread. In any embodiment, the non-linear path may form any desired non-linear path, such as any curvilinear path or any path composed of linear segments. In the exemplary embodiment shown, the non-linear path is a curvilinear path that includes a plurality of undulations.

It is appreciated that any tread discussed herein may be arranged along a tire, or may be formed separately from a tire as a tire component for later installation on a tire carcass, in accordance with any technique or process known to one of ordinary skill in the art. For example, the treads discussed and referenced herein may be molded with a new, original tire, or may be formed as a retread for later installation upon a used tire carcass during retreading operations. Therefore, when referencing the tire tread, a longitudinal direction of the tire tread is synonymous with a circumferential direction of the tire when the tread is installed on a tire. Likewise, a direction of the tread width is synonymous with an axial direction of the tire or a direction of the tire width when the tread is installed on a tire. Finally, a direction of the tread thickness is synonymous with a radial direction of the tire when the tread is installed on a tire. It is understood that the any tread as disclosed herein may be employed by any known tire, which may comprise a pneumatic or non-pneumatic tire, for example.

It is appreciated that any of the tread features discussed herein may be formed into a tire tread by any desired method, which may comprise any manual or automated process. For example, the treads may be molded, where any or all discontinuities therein may be molded with the tread or later cut into the tread using any manual or automated process. It is also appreciated that any discontinuity may be originally formed along, and in fluid communication with, the outer, ground-engaging side of the tread, or may be submerged below the outer, ground-engaging side of the tread, to later form a tread element after a thickness of the tread has been worn or otherwise removed during the life of the tire.

To the extent used, the terms “comprising,” “including,” and “having,” or any variation thereof, as used in the claims and/or specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the embodiments. Ranges that are described as being “between a and b” are inclusive of the values for “a” and “b” unless otherwise specified.

While various improvements have been described herein with reference to particular embodiments thereof, it shall be understood that such description is by way of illustration only and should not be construed as limiting the scope of any claimed invention. Accordingly, the scope and content of any claimed invention is to be defined only by the terms of the following claims, in the present form or as amended during prosecution or pursued in any continuation application. Furthermore, it is understood that the features of any specific embodiment discussed herein may be combined with one or more features of any one or more embodiments otherwise discussed or contemplated herein unless otherwise stated.

1. A tire tread comprising:
a length extending in a longitudinal direction, the lengthwise direction being a circumferential direction when the tread is arranged on a tire;
a width extending in a lateral direction, the lateral direction being perpendicular to the longitudinal direction;
a thickness extending in a depthwise direction from an outer, ground-engaging side of the tread, the depthwise direction being perpendicular to both the longitudinal direction and the widthwise direction of the tread;
a lateral discontinuity having a length and a height, the length extending primarily in the lateral direction of the tread and the height in the direction of the tread thickness;
where the lateral discontinuity is formed between a pair of opposing faces of the tread,
where a first face of the pair of opposing faces extends along a first path within the tread thickness, the first path extending from a first terminal end and to a second terminal end of the first face, the first terminal end being arranged closest to the outer, ground-engaging side relative to the second terminal end, the first path extending deeper into the tread thickness from the first terminal end at a first inclination angle measured in the longitudinal direction of the tread relative to the depthwise direction and an origin located below the first inclination angle, the first inclination angle being a low angle ranging from −10 to +20 degrees,
where the first face extends deeper into the tread thickness towards the second terminal end from the first inclination angle along the first path to an intermediate location of the first path located between the first terminal end and the second terminal end of the first face, where in the intermediate location the first path extends at a second inclination angle measured in the longitudinal direction of the tread relative to the depthwise direction and an origin located below the intermediate location, the second angle being angled away from an intended forward rotating direction of the tread relative to the second terminal end,
where the first face extends deeper into the tread thickness from the second inclination angle from the intermediate location and towards the second terminal end of the first face to a subsequent location along the first path, the first path extending at a third inclination angle at the subsequent location, the third inclination angle being measured in the longitudinal direction of the tread relative to the depthwise direction and an origin located below the first inclination angle, the third inclination angle being angled in the intended forward rotating direction of the tread relative to the second terminal end of the first face, and
where the first path, in extending from the first inclination angle and to the second inclination angle, transitions from the first inclination angle to a reduced angle that is less than the first angle and equal to or greater than zero.

2. The tire tread of claim 1, where the first inclination angle is measured at a first location.

3. The tire tread of claim 2, where the first location is the first terminal end of the first path.

4. The tire tread of claim 2, where the first location is located between the first terminal end and the intermediate location.

5. The tire tread of claim 1, where the first inclination angle is arranged within a first portion of the first path, the first portion extending from the first terminal end and to an intermediate portion within which the intermediate location is arranged.

6. The tire tread of claim 5, where a third location is arranged within a third portion of the first path, the third portion extending from the intermediate portion and to the second terminal end of the first path.

7. The tire tread of claim 1, where the path includes an undulation when extending from the first inclination angle and to the third inclination angle, the second inclination angle being arranged within the undulation.

8. The tire tread of claim 1, where the first inclination angle ranges from −5 to +10 degrees.

9. The tire tread of claim 1, where the second inclination angle is within the range of −10 to −50 degrees.

10. The tire tread of claim 1, where the third inclination angle is in the range of +30 to +80 degrees.

11. The tire tread of claim 1, where the reduced angle is −10 to +20 degrees.

12. The tire tread of claim 1, where the path is at least partially formed of a plurality of linear increments.

13. The tire tread of claim 1,
where a second face of the pair of opposing faces extends along a second path within the tread thickness, the second path extending from a first terminal end and to a second terminal end of the second face, the first terminal end being arranged closest to the outer, ground-engaging side relative to the second terminal end, the second path extending deeper into the tread thickness from the first terminal end at a first inclination angle measured in the longitudinal direction of the tread relative to the depthwise direction and an origin located below the first inclination angle, the first inclination angle being a low angle ranging from −10 to +20 degrees,
where the second face extends deeper into the tread thickness towards the second terminal end from the first inclination angle along the second path to an intermediate location of the second path located between the first terminal end and the second terminal end of the second face, where in the intermediate location the second path extends at a second inclination angle measured in the longitudinal direction of the tread relative to the depthwise direction and an origin located below the intermediate location of the second path, the second angle being angled away from an intended forward rotating direction of the tread relative to the second terminal end, and
where the second face extends deeper into the tread thickness from the second inclination angle from the intermediate location and towards the second terminal end of the second face to a subsequent location along the second path, the second path extending at a third inclination angle at the subsequent location, the third inclination angle being measured in the longitudinal direction of the tread relative to the depthwise direction and an origin located below the first inclination angle, the third inclination angle being angled in the intended forward rotating direction of the tread relative to the second terminal end of the second face.

14. The tire tread of claim 13, where the second path is the same as the first path of the first face.

15. The tire tread of claim 1, where the discontinuity is a sipe or a groove.

16. The tire tread of claim 1, where the first path extends into the tread thickness from the outer, ground-engaging side of the tread.

17. The tire tread of claim 1, where the tire tread is attached to a tire.
